(19) United States
(12) Patent Application Publication
(10) Pub. No.: US 2026/0064444 A1
(43) Pub. Date: Mar. 5, 2026

(54) METHOD AND APPARATUS FOR GENERATING USER INTERFACE AND STORAGE MEDIUM

(71) Applicant: Samsung Electronics Co., Ltd., Suwon-si (KR)

(72) Inventors: Xiao XU, Nanjing (CN); Jiang YU, Nanjing (CN); Longhai WU, Nanjing (CN); Jie CHEN, Nanjing (CN); Sungouk CHAE, Suwon-si (KR); Hyungrae KIM, Suwon-si (KR)

(21) Appl. No.: 19/352,855

(22) Filed: Oct. 8, 2025

Related U.S. Application Data
(63) Continuation of application No. PCT/IB2025/056716, filed on Jul. 2, 2025.

(30) Foreign Application Priority Data
Sep. 5, 2024 (CN) 202411246476.3

(51) Int. Cl. G06F 9/451; G06F 3/01; G06F 3/16

(52) U.S. Cl. CPC G06F 9/451; G06F 3/013; G06F 3/017; G06F 3/167

(57) ABSTRACT

A method and apparatus for generating a user interface and storage medium are provided. The method includes acquiring environmental information and user body information of a user, determining a target projected region according to three-dimensional space information of an environment where the user is located, three-dimensional space information of the user own body and user operation intention, determining layout prompt words according to the target projected region and user operation intention, and determining user interface layout information according to the target projected region and the layout prompt words using a first diffusion model, determining user interface prompt words according to user operation intention, and generating the user interface using a second diffusion model according to the target projected region, user interface layout information and the user interface prompt words.

### CROSS-REFERENCE TO RELATED APPLICATION(S)

This application is a continuation application, claiming priority under 35 U.S.C. § 365 (c), of an International Application No. PCT/IB2025/056716, filed on Jul. 2, 2025, which is based on and claims the benefit of a Chinese patent application number 202411246476.3, filed on Sep. 5, 2024, in the Chinese Intellectual Property Office, the disclosure of which is incorporated by reference herein in its entirety.

### TECHNICAL FIELD

The disclosure relates to the technical field of Internet of things (IoT). More particularly, the disclosure relates to a method for generating a user interface, an apparatus for generating a user interface, a computer-readable storage medium and a computer program product.

### BACKGROUND ART

A projector projects on a reserved region, such as a white wall or a curtain, without a display, so that a better projection effect can be obtained. If the user needs to operate the projected picture, it is necessary to use an external device, such as a remote controller or a keyboard. With the development of technology, a user can directly interact with a projected picture without an external electronic device, such as a remote controller or a keyboard to achieve the effect of touch control, that is: the projector projects the user interface and the user operates directly on the projected picture for control. However, if the projected region is not ideal, such as the presence of contamination, occlusion or irregularity, the projection effect is affected. In practice, it may be difficult for a user to find a suitable region as a projected region, and a projector cannot flexibly generate a high-quality user interface accordingly, and cannot meet the user's requirements.

The above information is presented as background information only to assist with an understanding of the disclosure. No determination has been made, and no assertion is made, as to whether any of the above might be applicable as prior art with regard to the disclosure.

### Technical Solution

Aspects of the disclosure are to address at least the above-mentioned problems and/or disadvantages and to provide at least the advantages described below. Accordingly, an aspect of the disclosure is to provide a method for generating a user interface, which can overcome the defect of a poor projection effect caused by a non-ideal projected region, and achieve the purpose of flexibly generating a high-quality user interface according to actual situations.

Additional aspects will be set forth in part in the description which follows and, in part, will be apparent from the description, or may be learned by practice of the presented embodiments.

In accordance with an aspect of the disclosure, a method for generating a user interface is provided. The method includes acquiring environmental information and user body information of a user, wherein the environmental information includes three-dimensional space information of an environment where the user is located, and the user body information includes three-dimensional space information of the user own body, determining a target projected region according to the three-dimensional space information of the environment where the user is located, the three-dimensional space information of the user own body and an acquired user operation intention, determining layout prompt words according to the target projected region and the user operation intention, where the layout prompt words are prompt information describing a user interface layout, determining user interface layout information according to the target projected region and the layout prompt words using a first diffusion model, determining user interface prompt words according to the user operation intention, where the user interface prompt words are prompt information describing a user interface appearance, and generating a user interface using a second diffusion model according to the target projected region, user interface layout information and the user interface prompt words.

In accordance with another aspect of the disclosure, an apparatus for generating a user interface, which can overcome the defect of a poor projection effect caused by a non-ideal projected region, and achieve the purpose of flexibly generating a high-quality user interface according to actual situations is provided.

In accordance with another aspect of the disclosure, an apparatus for generating a user interface is provided. The apparatus includes memory, including one or more storage media, storing instructions, and at least one processor communicatively coupled to the memory, wherein the instructions, when executed by the at least one processor individually or collectively, cause the apparatus to acquire environmental information and user body information of a user, wherein the environmental information includes three-dimensional space information of an environment where the user is located, and the user body information includes three-dimensional space information of the user's own body, determine a target projected region according to the three-dimensional space information of the environment where the user is located, the three-dimensional space information of the user own body and an acquired user operation intention, determine layout prompt words according to the target projected region and the user operation intention, wherein the layout prompt words are prompt information describing a user interface layout, determine user interface layout information according to the target projected region and the layout prompt words using a first diffusion model, determine user interface prompt words according to the user operation intention, wherein the user interface prompt words are prompt information describing a user interface appearance, and generate a user interface using a second diffusion model according to the target projected region, user interface layout information and the user interface prompt words.

In accordance with another aspect of the disclosure, one or more non-transitory computer-readable storage media storing one or more computer programs including computer-executable instructions that, when executed by at least one processor of an apparatus individually or collectively, cause the apparatus to perform operations are provided. The operations include acquiring environmental information and user body information of a user, wherein the environmental information comprises three-dimensional space information of an environment where the user is located, and the user body information comprises three-dimensional space information of the user own body, determining a target projected region according to the three-dimensional space information of the environment where the user is located, the three-dimensional space information of the user own body and an acquired user operation intention, determining layout prompt words according to the target projected region and the user operation intention, wherein the layout prompt words are prompt information describing a user interface layout, determining user interface layout information according to the target projected region and the layout prompt words using a first diffusion model, determining user interface prompt words according to the user operation intention, wherein the user interface prompt words are prompt information describing a user interface appearance, and generating a user interface using a second diffusion model according to the target projected region, user interface layout information and the user interface prompt words.

In accordance with another aspect of the disclosure, a computer program product, which can overcome the defect of a poor projection effect caused by a non-ideal projected region, and achieve the purpose of flexibly generating a high-quality user interface according to actual situations is provided.

In summary, in the embodiments of the disclosure, determine the target projected region by acquiring the environmental information and the user body information of the user as well as the user's intention. On this basis, two diffusion models are configured to generate the user interface layout information and the final user interface respectively, so that a high-quality user interface can be flexibly generated according to the actual situation in any scenario to meet the requirements of users.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a flow chart according to Embodiment 1 of a method according to an embodiment of the disclosure;

FIG. 2 is a flow chart according to Embodiment 2 of a method according to an embodiment of the disclosure;

FIG. 3 is a scenario diagram according to Embodiment 2 of a method according to an embodiment of the disclosure;

FIG. 4 is a flow chart according to Embodiment 3 of a method according to an embodiment of the disclosure;

FIG. 5 is a scenario diagram according to Embodiment 3 of a method according to an embodiment of the disclosure; and

FIG. 6 is a structural diagram illustrating an apparatus for generating a user interface according to Embodiment 1 according to an embodiment of the disclosure.

The same reference numerals are used to represent the same elements throughout the drawings.

### MODE FOR INVENTION

The following description with reference to the accompanying drawings is provided to assist in a comprehensive understanding of various embodiment of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms “first”, “second”, “third”, “fourth”, and the like in the description and in the claims of the disclosure and in the above-described figures, if any, are used for distinguishing similar objects and not necessarily for describing a particular sequential or chronological order. It is to be understood that the data thus used are interchangeable under appropriate circumstances such that the embodiments of the disclosure described herein are capable of being implemented for example in sequences other than those illustrated or otherwise described herein. Further, the terms “comprise” and “have”, as well as any variations thereof, are intended to cover a non-exclusive inclusion. For example, a process, method, system, product, or device that includes a list of steps or units is not necessarily limited to those steps or units expressly listed, but may include other steps or units not expressly listed or inherent to such process, method, product, or apparatus.

Hereinafter, the technical solution of the disclosure will be described with reference to specific embodiments. The following specific embodiments may be combined with each other, and the same or similar concepts or processes may not be repeated in some embodiments.

The projector may be a fixed projector or a movable projector. The fixed projector is fixed at a certain position for the projection operation, while the movable projector can be carried around to seek a suitable angle for the projection at any suitable position. The projector can be connected to various smart devices such as a computer, a tablet computer, a mobile phone, an smart switch, or the like. In practice, in cases where the projected region is not ideal (e.g., being obscured by obstacles, being dirty or being irregular regions, or the like), the related art generally corrects the projected effect by reducing the size of the projected image, otherwise poor visual effects are often caused by the projected region being not ideal.

As described above, in the prior art, in the case where the projected region is not ideal, it is difficult to find a suitable region, and it is impossible to flexibly achieve a high-quality projection effect according to the actual situation. In view of the defects of the prior art, the embodiments of the disclosure propose a method for generating a user interface, which can be internally mounted in a projector or deployed separately, and can flexibly generate a high-quality user interface according to the actual situation of a projected region to satisfy user requirements.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

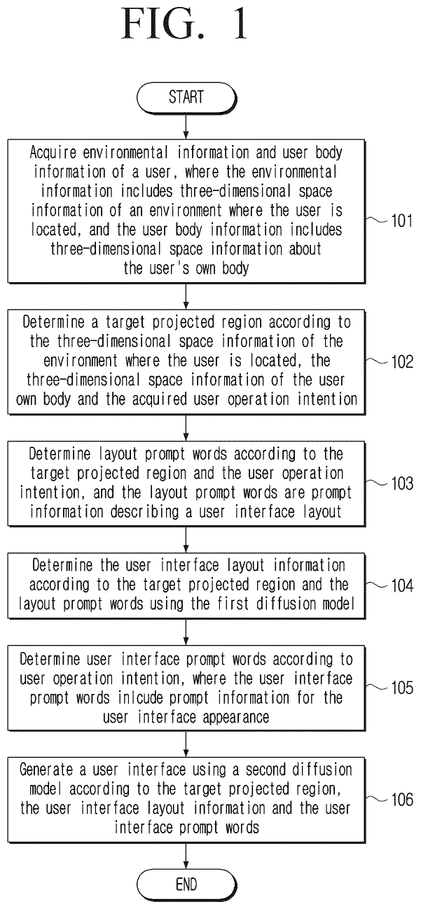

FIG. 1 is a flow chart according to Embodiment 1 of a method according to an embodiment of the disclosure.

Referring to FIG. 1, the method includes:

Operation 101: Acquire environmental information and user body information of a user, where the environmental information includes three-dimensional space information of an environment where the user is located, and the user body information includes three-dimensional space information about the user's own body.

In practice, an acquisition device, such as a three-dimensional camera, can be mounted in a space environment where a user is located, for acquiring environmental information and user body information of the user and the acquired data can be three-dimensional data or point cloud data, or the like. The acquisition device may be deployed within the projector or deployed separately. The environmental information is three-dimensional space information of an environment where a user is located, and can include but is not limited to describing the length, width and height dimensions of a space environment, describing the length, width and height dimensions of an object, and can further detect and analyze attribute information such as an object name, an object material and an object softness and hardness. The user own body information is characteristic information describing a three-dimensional space occupied by each body part of the user, and may include but is not limited to a human body height and a human body proportion; and bone detection and bone point detection can also be performed and the length and size of the bone can be analyzed, thereby determining the size of each body part, or the like. In practice, when detecting and analyzing the environmental information and the user body information of the user, the detecting and analyzing can be realized by using prior art, such as image segmentation and depth estimation, which will not be described herein.

In addition, this operation can also generate a two-dimensional spatial environment image. The two-dimensional spatial environment image may be generated by mapping the acquired three-dimensional data or may be generated directly by a two-dimensional camera, which will not be limited herein.

Operation 102: Determine a target projected region according to the three-dimensional space information of the environment where the user is located, the three-dimensional space information of the user own body and the acquired user operation intention.

After acquiring the three-dimensional space information of the environment where the user is located and the three-dimensional space information about the user own body, it is possible to determine which regions can be used for projection and which regions are touchable by the user body. In an embodiment of the disclosure, in order to facilitate the user to operate the projected picture, the regions available for projection can be screened one by one by taking the user as a center. The screened regions are those that the user can touch with a part of the body, such as a hand. There may be a plurality of projected regions meeting the screening condition, and in this operation, one may be selected as the target projected region according to the user operation intention. The user operation intention described herein refers to a user's voluntary meaning expression, and the user operation intention can be acquired by detecting any one or a combination of more of a user voice, a user gesture, a user eyesight, a user facial expression, or in a pre-setting manner. For example, if a user lifts his right hand, the region closest to the user's right hand may be used as the target projected region. Alternatively, if a user is a left-hander, he lifts his left hand, the region closest to the user's left hand may be used as the target projected region. Alternatively, a user lifts his right leg, and a region closest to the user's right leg may be used as the target projected region. Alternatively, if a user speaks to project directly in front of the face, the region directly in front of the face may be used as the target projected region. In summary, this operation can determine the target projected region according to the three-dimensional space information of the environment in which the user is located and the three-dimensional space information of the user own body, and in compliance with the user operation intention. The target projected region is the region to be projected after the user interface is subsequently generated.

Operation 103: Determine layout prompt words according to the target projected region and the user operation intention, and the layout prompt words are prompt information describing a user interface layout.

In practice, the target projected region used by different users may be different, the target projected region used by the same user at different times may be different, the elements of the user interface may be different in different situations, or the like. The target projected region may be a regular region or an irregular region, may be a large region or a small region, and there may be more or less elements of the user interface. In order to generate a more reasonable and attractive user interface, the user interface layout may need to be considered in this embodiment. Not only the target projected region but also the user operation intention is considered in this operation when planning user interface layout. As described above, the user operation intention may be obtained by detecting any one or a combination of more of a user voice, a user gesture, a user eyesight, a user facial expression, or in a pre-setting manner. For example, if the user wants to arrange the elements of the user interface in a matrix manner, the user operation intention can be determined in a pre-setting manner, or the voice indicates “an uncongested arrangement manner”, and then the layout prompt words “the number of rows=4, and the number of columns=3” may be obtained through calculation according to the algorithm. This is merely a simple example, which is not limited in practice, as long as prompt information describing user interface layout can be generated.

Operation 104: Determine the user interface layout information according to the target projected region and the layout prompt words using the first diffusion model.

After the target projected region and layout prompt words are determined, a diffusion model is used to complete the layout in this operation. The diffusion model is a probability-based generation model, which learns the distribution of data by simulating the generation process of data, and can generate new data samples from the learned distribution. The core principles of diffusion model include forward diffusion process and backward diffusion process, which together form the basis of diffusion model. Forward diffusion process: this process simulates the generation of data by gradually adding noise to the data. This process is irreversible, and the original data is gradually “diffused” or “contaminated” by gradually increasing the noise, eventually becoming noise data of Gaussian distribution. The backward diffusion process: in contrast to the forward diffusion process, the backward diffusion process learns the ability to recover the original data from the noised data. A neural network model may be trained to gradually predict and remove noise from the noised data, and finally recover the original data samples.

In an embodiment of the disclosure, the first diffusion model may be pre-trained using a large number of samples, i.e., using a large number of different projected regions, a large number of different layout prompt words and a large number of different layout information, so that the first diffusion model learns how to generate a reasonable and attractive layout according to the layout prompt words for the different projected regions. The layout information described in this operation can be an abstract layout structure, and can also be a specifically displayed layout picture.

Operation 105: Determine user interface prompt words according to user operation intention, where the user interface prompt words include prompt information for the user interface appearance.

As described above, the user operation intention may be obtained by detecting any one or a combination of more of a user voice, a user gesture, a user eyesight, a user facial expression, or in a pre-setting manner. User interface prompt words may be further determined in this operation based on the user operation intention. For example, if the user speaks or pre-sets his preferred “blue stereoscopic style”, user interface prompt words “color=blue, shape=stereo” may be generated. This is merely a simple example, and the practical application is not limited thereto, as long as prompt information describing the user interface appearance can be generated.

Operation 106: Generate a user interface using a second diffusion model according to the target projected region, the user interface layout information and the user interface prompt words.

After determining the user interface layout information and the user interface prompt words, a diffusion model is used to complete the generation of the final user interface. To distinguish from the diffusion model for determining layout in operation 104, the diffusion model in this operation 106 is referred to as a second diffusion model. In an embodiment of the disclosure, the second diffusion model can be pre-trained using a large number of samples, i.e., using a large number of different projected regions, a large number of different user interface layout information and a large number of different user interface prompt words, so that the second diffusion model learns how to generate a final user interface according to the user interface prompt words aiming at different projected regions and user interface layout information. The final user interface generated here will conform to the shape of the target projected region, be displayed in a reasonable layout configuration and in a style preferred by the user.

With the solution of Embodiment 1 of the method of the disclosure, a user interface can be flexibly generated according to an appropriate position of an environment where a user is located. Thereafter, the generated user interface is projected onto the target projected region and provided to the user to realize the user operation intention, i.e., the user conveniently operates the user interface in the touchable target projected region without using the remote control or keyboard and other electronic devices, which greatly meets the user's requirements.

In another embodiment of the disclosure, since the environmental information and user body information of the user are acquired, i.e., the three-dimensional space information of the environment where the user is located is acquired, and the three-dimensional space information occupied by each body part of the user is also acquired, it is possible to determine which regions are touchable by the user, and then a region is screened out as a target projected region according to the acquired user operation intention. The user touchable region refers to a region touchable by a certain body part of the user, such as touching with hands or feet; or the object may be touchable, for example, by a walking stick used by an elderly person. The target projected region may be a touchable projected region convenient for a user to operate, and may be a regular region or an irregular region which is surrounded by any irregular geometry, such as triangles, trapezoids, semi-circles, hexagons, and other irregular geometries.

In practice, a fixed projector may be fixedly mounted outdoors or indoors, and a movable projector may move with the user from indoors to outdoors, or vice versa. If it is mounted indoors, it is difficult to find a certain blank regular region indoors easily and flexibly since itis always blocked by furniture appliances or various other home appliances indoor. For example, before leaving, the user wants to project the user interface of various indoor electrical switches (air conditioner, television, lamp, or the like) to the side of the door, and the side of the door is covered by sundries such as access control, leaving only a part of the irregular region available. As another example, a user may wish to project a user interface on a wall within a child's bedroom, but the wall is soiled by graffiti, leaving only a portion of the irregular region available. Such irregular regions due to the actual situation differ from regular regions dedicated to projection. If the user interface is projected directly into an irregular region, it is likely that the projected picture will be illegible or inconvenient for the user to touch due to occlusion or fouling.

As described above, the diffusion model includes a forward diffusion process and a backward diffusion process, which together form the basis of the diffusion model. The first diffusion model training process is described below.

Before the first diffusion model training, a large number of training samples, such as a large number of regular regions and irregular regions, and a large number of layout prompt words, need to be collected. In the specific implementation, it contains rich layout and user interface elements, so that the model learns the distribution and boundary characteristics of various regular and irregular regions, and then uses the strategy generated by conditions, and considers the spatial efficiency and aesthetics of various element arrangement in the generation process, and optimizes the layout of each element to generate a reasonable layout in the projected region of various shapes.

In the forward diffusion process, clear user interface layout information can be used as the original data to gradually introduce noise thereto, and finally the noise becomes pure noise to complete the diffusion process. This process can be represented as:

$${x}_{t + 1} = \sqrt{1 - {β}_{t}} {x}_{t} + \sqrt{{β}_{t}} {ε}_{t}$$

where xₜ₊₁ is a data state at time step t, βₜ is a pre-set noise level parameter, \sqrt{1−βₜxₜ} represents the retained part of the current state xₜ, εₜ is the noise sampled from a standard normal distribution, and \sqrt{βₜ}εₜ is the added noise. As the time step t increases, the data becomes increasingly blurred and noisy from the original clear state until eventually becoming almost completely random noise x_{T} at the time step T.

In the backward diffusion process, the original data is gradually recovered from the noise data. The backward diffusion process learns to remove the noise gradually from the Gaussian noise, returns to the mapping of the original data distribution, and recovers a clean data state from a highly noisy state. The backward diffusion process can be represented as:

$${x}_{t - 1} = \frac{1}{\sqrt{1 - {β}_{t}}} ( {x}_{t} - \frac{{β}_{t}}{\sqrt{1 - {α}_{t}}} {ε}_{θ} ( {x}_{t} , t ) ) + {σ}_{t} z$$

where βₜ is a pre-set noise level parameter representing the proportion of noise added to the data at time step t, and controlling the amount of noise introduced at each step. αₜ is then defined as the proportion of data remaining in the same time step, i.e., the part of the data that is not covered by noise, usually let αₜ=1−βₜ. ε_{θ}(xₜ,t) is a parameterized network representing the noise estimated by the neural network model based on the current data state xₜ and the time step t. In an embodiment of the disclosure, the parameterized network represented by ε_{θ}(xₜ,t) further includes layout prompt words, which are a form in which the text description is encoded, typically by some form of text encoder, such as Transformer or BERT. σₜ is a standard deviation adjusted over time to control the amount of added random noise [symbol] , where [symbol] is a random noise vector sampled from a standard normal distribution. The backward diffusion process needs to predict which noise should be removed from the current noise image based on the noise image, time step, layout prompt words, or the like.

Using the forward diffusion process and the backward diffusion process described above, the first diffusion model will learn how to generate clear and unambiguous user interface layout information from pure noise.

The first diffusion model is trained, and then only the backward diffusion process is used in actual use. In each operation, the first diffusion model uses the backward diffusion model learned during training to infer layout information for the denoised user interface. For example, the above-mentioned operation 104 of determining user interface layout information using a first diffusion model according to the target projected region and the layout prompt words specifically includes: the three-dimensional space information and the layout prompt words of the target projected region are taken as an input of the first diffusion model, and the user interface layout information is output through calculation of the first diffusion model, where the first diffusion model is a model pre-trained by the above-mentioned method. In practice, the first diffusion model also requires other necessary input information to complete the calculation, and the embodiment of the disclosure emphasizes three-dimensional space information and layout prompt words of the target projected region to generate user interface layout information conforming to the layout prompt words for the target projected region. The generated layout information may be an image representing a layout frame.

In another embodiment of the disclosure, operation 103 may determine layout prompt words according to the target projected region and the user operation intention, specifically including:

Operation 103: Perform three-dimensional detection on the target projected region, and determine three-dimensional spatial parameter estimation of an object in the target projected region, where the three-dimensional spatial parameter estimation is spatial position information describing the object in the target projected region.

After the target projected region is determined, three-dimensional detection can also be performed again in the region to determine three-dimensional parameter estimation of the object in the target projected region. For example, it is determined whether there are abnormal situations such as an obstacle, a concave-convex part or a dirty part in a region, and a three-dimensional parameter estimation of these abnormal situations, i.e., a parameter such as a size, a dimension and a three-dimensional coordinate is calculated.

Operation 103: Determine a layout in the target projected region according to the three-dimensional spatial parameter estimation of the object in the target projected region, and generate the layout prompt words from the layout.

Three-dimensional spatial parameter estimation of objects within the target projected region is determined, and then user interface layout can be designed based on these anomalies. For example, when there is an obstacle, a concave-convex part or a dirty part in the middle of the target projected region, the elements of the user interface may not be laid out at these locations, but instead around the middle portion. For another example, when there is an obstacle, a concave-convex part or a dirty part on the right side in the target projected region, the layout may be changed to two columns and six rows instead of the original three columns and four rows, and the layout may. In summary, in the embodiments of the disclosure, a reasonable layout can be calculated according to actual situations in a target projected region, and layout prompt words may be generated.

After the layout is generated, only the framework of the user interface is determined, and specific elements also need to be filled into the user interface, i.e., generating a real user interface. Similar to the first diffusion model, embodiments of the disclosure also adopt a diffusion model to generate the final user interface, i.e., the second diffusion model. The second diffusion model training process is described below.

Before training the second diffusion model, a large number of training samples are collected, such as a large number of regular and irregular regions, a large number of user interface layout information and a large number of user interface prompt words. When the model is implemented, it contains rich user interface elements, such as control types and control positions, or the like. These information can be represented as structured data, such as JSON format, so that the model can learn the user interface characteristics of various rules and irregular regions, and can also use data enhancement technology to enable the model to have better generalization ability.

In the forward diffusion process, the clear user interface can be used as the original data to gradually introduce noise and finally become pure noise to complete the diffusion process. This process can be represented as:

$${y}_{t + 1} = \sqrt{1 - {b}_{t}} {y}_{t} + \sqrt{{b}_{t}} {ε}_{t}$$

Where yₜ₊₁ is a data state at time step t, bₜ is a pre-set noise level parameter, \sqrt{1−bₜ}yₜ represents the retained of the current state yₜ, εₜ is the noise sampled from a standard normal distribution, and \sqrt{bₜ}εₜ is the added noise. As the time step t increases, the data becomes increasingly blurred and noisy from the original clear state until eventually becoming almost completely random noise Yr at the time step T.

In the backward diffusion process, the original data is gradually recovered from the noise data. The backward diffusion process learns to remove the noise gradually from the Gaussian noise, returns to the mapping of the original data distribution, and recovers a clean data state from a highly noisy state. The backward diffusion process can be represented as:

$${y}_{t - 1} = \frac{1}{\sqrt{1 - {b}_{t}}} ( {x}_{t} - \frac{{b}_{t}}{\sqrt{1 - {a}_{t}}} {ε}_{0} ( {y}_{t} , t ) ) + {σ}_{t} z$$

where bₜ is a pre-set noise level parameter representing the proportion of noise added to the data at time step t, and controlling the amount of noise introduced at each step. aₜ is then defined as the proportion of the data remaining in the same time step, i.e., the part of the data not covered by noise, usually let aₜ=1−bₜ. ε_{θ}(yₜ,t) is a parameterized network representing the noise estimated by the neural network model based on the current data state yₜ and the time step t. In an embodiment of the disclosure, the parameterized network represented by ε_{θ}(yₜ,t) further includes user interface prompt words, which are a form in which the text description is encoded, typically by some form of text encoder, such as Transformer or BERT. σₜ is a standard deviation adjusted over time to control the amount of added random noise [symbol] , where [symbol] is a random noise vector sampled from a standard normal distribution. The backward diffusion process needs to predict which noise should be removed from the current noise image based on the noise image, time step, user interface prompt words, or the like.

Using the forward diffusion process and the backward diffusion process described above, the second diffusion model will learn how to generate clear and unambiguous user interface from pure noise.

The second diffusion model is trained, and then only the backward diffusion process is used in actual use. In each operation, the second diffusion model uses the backward diffusion model learned during training to infer the denoised user interface. For example, the above-mentioned operation 106 of generating a user interface using a second diffusion model according to the target projected region, the user interface layout information and the user interface prompt words specifically includes: three-dimensional space information of a target projected region, user interface layout information and user interface prompt words are taken as inputs of a second diffusion model, and the user interface is output through calculation of the second diffusion model, where the second diffusion model is a pre-trained model. In practice, the second diffusion model also requires other necessary input information to complete the calculation, and the embodiment of the disclosure emphasizes three-dimensional space information of the target projected region and user interface prompt words to generate a user interface conforming to the user interface prompt words for the target projected region. In practice, trapezoidal correction can also be performed on the generated user interface, so that the projected picture effect is better.

In other embodiments of the disclosure, the operation 105 of determining user interface prompt words according to user operation intention, where the user interface prompt words include prompt information for the user interface appearance, specifically includes:

Operation 105: Determine a user interface style for the target projected region according to the user operation intention, where the user interface style includes information describing a style of the user interface appearance.

Interface styles may be different for different user preferences. The interface style described herein is information describing the style of the user interface appearance, such as interface border color, button color, whether it is stereoscopic, whether it is shaded, text size, text font, or the like. The user operation intention may be obtained by detecting any one or a combination of more of a user voice, a user gesture, a user eyesight, a user facial expression, or in a pre-setting manner. For example, if the user is determined to be young women, a pink series style user interface may be determined for the user.

Operation 105: Determine the user interface prompt words for the target projected region according to the user interface style.

After determining user interface style, and then user interface prompt words may be determined based thereon. Taking the above operations as an example, if the user is determined to be a young woman, the user interface prompt words may be generated as a “pink series style”. In summary, embodiments of the disclosure may generate accurate and reasonable user interface prompt words based on user operation intention.

In method Embodiment 2, the solution of the disclosure is applied to an indoor teaching scenario. In this scenario, the projector may be a fixed projector and embodiments of the disclosure are combined with the fixed projector. The projector may also be a movable projector, and the technical solution of embodiments of the disclosure are combined with the movable projector. The projector is mounted in a room in a direction facing the blackboard, and has a built-in camera, and a sensor, or the like. The projector projects the PPT of teaching content in front of the blackboard and detects the classroom environmental information and the teacher's body information in real time. The detected classroom environmental information is the environmental information of the user, and the body information of the teacher is the user body information. The teacher walks back and forth in front of the platform blackboard and wants to generate PPT operation buttons in an appropriate area when needing to manipulate the PPT. In order to simplify the problem, in an embodiment of the disclosure, the PPT operation button is divided into three types of “the next page”, “the last page” and “exit”. For example, the method of the embodiment of the disclosure is capable of generating a PPT operation button in an appropriate area to provide the teacher with an operation in a scenario where the user walks to and from while speaking. The methods of the embodiments of the disclosure are described below.

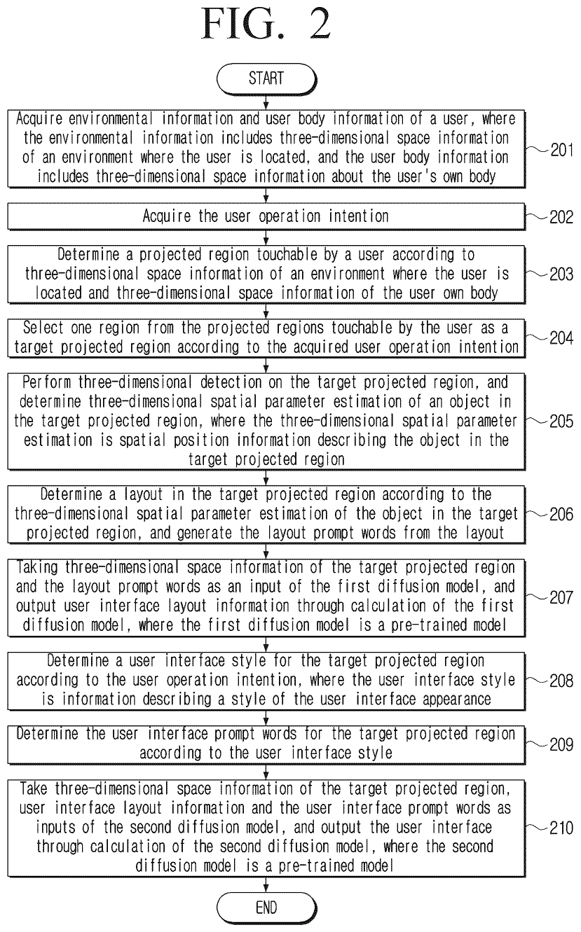

FIG. 2 is a flow chart according to Embodiment 2 of a method according to an embodiment of the disclosure.

Referring to FIG. 2, the method includes:

Operation 201: Acquire environmental information and user body information of a user, where the environmental information includes three-dimensional space information of an environment where the user is located, and the user body information includes three-dimensional space information about the user's own body.

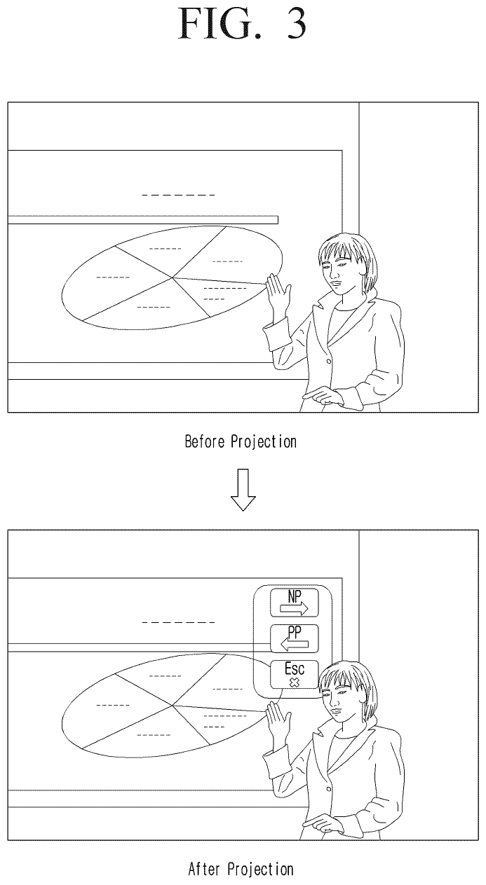

FIG. 3 is a scenario diagram according to Embodiment 2 of a method according to an embodiment of the disclosure.

Referring to FIG. 3, the teacher usually demonstrates the PPT standing next to the platform and often also points something in the PPT with a finger while speaking. A camera in the projector can detect environmental information such as an indoor blackboard and a platform and a PPT, such as the size, dimension and three-dimensional coordinates of the indoor blackboard and the platform, what are contents in the PPT, which are blank regions and the location, shape and size of the blank regions in the PPT, and can also detect teacher body information, such as a human body, a human body proportion and the size of various body parts.

Operation 202: Acquire the user operation intention.

The user operation intention may be obtained by detecting any one or a combination of more of a user voice, a user gesture, a user eyesight, a user facial expression, or in a pre-setting manner. In the embodiment of the disclosure, since the camera and the sensor are internally mounted in the projector, the body information of the teacher can be detected, and the sound, facial expression, gesture, posture, or the like, of the teacher can also be detected, from which the user operation intention can be determined. For example, when the teacher has finished to demonstrate a page of the PPT, and lift his right hand to turn the page, it is determined that his user operation intention is to click to reach the next page. For another example, the teacher says “we have just talked about . . . ” and lifts his right hand to turn a page, it is determined that his user operation intention is to click to reach the last page. As for how to acquire the user operation intention according to any one or a combination of more of user voice, user gesture, user eyesight and user facial expression, or in a pre-setting manner, it can be achieved by the prior art and will not be described here.

Operation 203: Determine a projected region touchable by a user according to three-dimensional space information of an environment where the user is located and three-dimensional space information of the user own body.

After collecting the three-dimensional space information of the environment where the user is located and the three-dimensional space information of the user own body, it is possible to determine the region where the user's body can touch and can be used for projection. To facilitate the user operating the projected picture, the regions available for projection can be screened one by one by taking the teacher as the center. The screened regions are regions that are touchable by a user with a certain part of the body (such as a hand), and there may be multiple projected regions meeting the screening conditions.

Operation 204: Select one region from the projected regions touchable by the user as a target projected region according to the acquired user operation intention.

Since there may be a plurality of projected regions meeting the screening conditions, an optimal projected region needs to be selected therefrom. The way by which the best projected region is selected may be determined based on the user operation intention. For example, if the teacher stands on the right side of the PPT and lifts his right hand, it can be determined that the teacher wants to operate the button with his right hand, and the projected region touchable by the user nearest to the right hand of the teacher can be used as the target projected region.

Operation 205: Perform three-dimensional detection on the target projected region, and determine three-dimensional spatial parameter estimation of an object in the target projected region, where the three-dimensional spatial parameter estimation is spatial position information describing the object in the target projected region.

After determining the target projected region, it is also necessary to determine the three-dimensional parameter estimation of the object in the target projected region to facilitate the subsequent reasonable layout. In an embodiment of the disclosure, it is assumed that the region where PPT is located is taken as the target projected region. Since the content is displayed on the PPT, if the PPT operation button is directly overlaid and projected on the content, the picture effect is not good and difficult to recognize, the target projected region can be detected, and which positions have been overlaid with content can be detected and which positions are relatively blank can be detected in this operation. It should be noted that the three-dimensional detection performed in this operation is to determine a three-dimensional spatial parameter estimation of an object in a target projected region, and may include coordinates in three directions of X, Y and Z; however, for the contents in the PPT plane, the coordinate in the Z direction may be set as 0, and only two directions of X and Y may be detected.

Operation 206: Determine a layout in the target projected region according to the three-dimensional spatial parameter estimation of the object in the target projected region, and generate the layout prompt words from the layout.

Assuming that the region where the upper right side of the PPT is located is taken as the target projected region, the specific situation within the target projected region can be determined through three-dimensional detection. It can be seen from FIG. 3 that the left-right width of the blank part on the upper right side is small and the top-bottom width of the blank part on the upper right side is large, which is suitable for arranging the PPT operation buttons in a longitudinal direction, and thus corresponding prompt words, such as “one column and three rows”, can be generated.

Operation 207: Taking three-dimensional space information of the target projected region and the layout prompt words as an input of the first diffusion model, and output user interface layout information through calculation of the first diffusion model, where the first diffusion model is a pre-trained model.

The first diffusion model here can be trained for the forward diffusion process and the backward diffusion process according to the method as described above. This operation is to directly use the trained backward diffusion process, take the three-dimensional space information and the layout prompt words of the target projected region as input, and obtain the user interface layout information by calculating from the trained first diffusion model, i.e., specifically generating one column and three rows of operation button frames.

Operation 208: Determine a user interface style for the target projected region according to the user operation intention, where the user interface style is information describing a style of the user interface appearance.

This embodiment assumes that the user operation intention is to acquire the “blue concise style” by preseting, and then the user interface style of the target projected region can be determined as “blue concise style” in this operation.

Operation 209: Determine the user interface prompt words for the target projected region according to the user interface style.

According to the user interface style of the target projected region, the user interface prompt words are determined as “blue concise style” in this operation.

Operation 210: Take three-dimensional space information of the target projected region, user interface layout information and the user interface prompt words as inputs of the second diffusion model, and output the user interface through calculation of the second diffusion model, where the second diffusion model is a pre-trained model.

The second diffusion model here can also be trained for the forward diffusion process and the backward diffusion process according to the method as described above. Using the trained backward diffusion process directly, the three-dimensional space information of the target projected region, the user interface layout information and the user interface prompt words are taking as inputs, and the user interface can be obtained by calculating from the trained second diffusion model in this operation. It is assumed that “next page” is represented by a right arrow, “last page” is represented by a left arrow, and “exit” is represented by a cross, i.e., a column of three rows of operation buttons are specifically generated, and the operation buttons are displayed as a blue concise pattern according to the user's intention. In practice, other types of buttons may also be generated, such as a “drawing tool” button, so that the teacher can perform drawing operations on the PPT at any time.

Operation 211: Project the user interface to the target projected region, and provide the user interface to the user to realize the user operation intention.

In practice, due to the mounting angle of the projector, the generated user interface can also be corrected using a trapezoidal correction method and then projected. Referring to FIG. 3, the operation button will be presented on the upper right side of the PPT after the user interface generated by the embodiment of the disclosure being projected on the target projected region. Thus, the teacher does not need to walk to the computer or operate with the device, but only operate the PPT operation button projected near his right hand.

FIG. 3 is merely a simple example and is not intended to limit the protection scope of the embodiments of the disclosure. It will be appreciated that PPT operation buttons may also be generated in other regions using methods of the embodiments of the disclosure. For example, when the teacher walks to the left side of the PPT, the PPT operation button can be generated on the left side, or when the teacher walks to the side of the desk, the PPT operation button can be projected on the desk, and the projected layout and style thereof are related to the actual target projected region and the user's intention to achieve the purpose of flexibly projecting to meet the user's requirements.

In method Embodiment 3, the solution of the disclosure is applied at a scenario of being at home or in an office. In this scenario, the projector may be mounted in a living room, bedroom, kitchen, office region, or the like, and has a built-in camera and sensor, or the like. The camera and sensor may also be deployed separately. The camera and the sensor detect the home or office environmental information and the user body information in real time, and the detected home or office environmental information is the environmental information of the user. The user walks freely at home or in an office, and wishes to turn off the switch of some appliances in the room before leaving or adjust the sound volume. To simplify matters, the user interface is configured as a switch button of an appliance in the embodiments of the disclosure. However, in practice, the user interface is not limited to the switch button, but any interface that interacts with the user is possible and is not limited to the embodiments of the disclosure. The methods of the embodiments of the disclosure are described below.

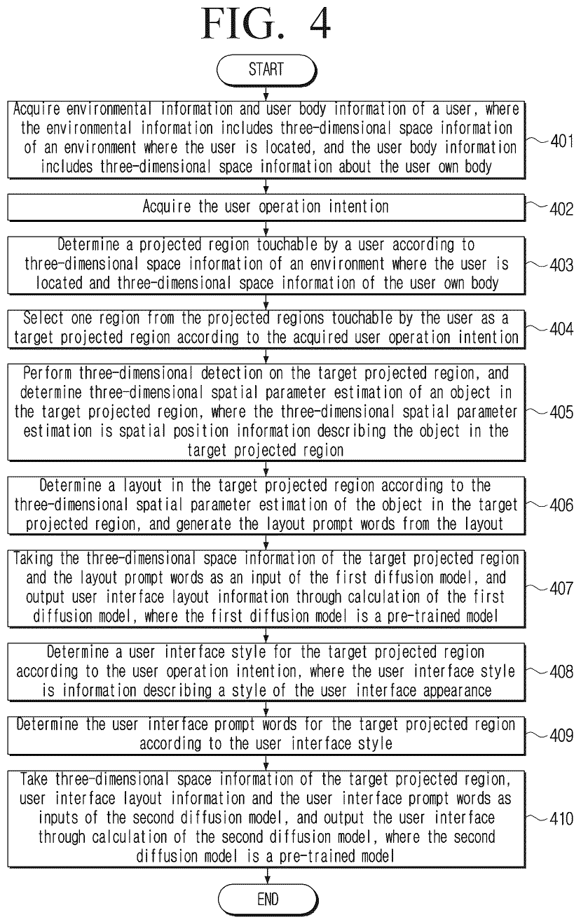

FIG. 4 is a flow chart according to Embodiment 3 of a method according to an embodiment of the disclosure.

Referring to FIG. 4, the method includes:

Operation 401: Acquire environmental information and user body information of a user, where the environmental information includes three-dimensional space information of an environment where the user is located, and the user body information includes three-dimensional space information about the user own body.

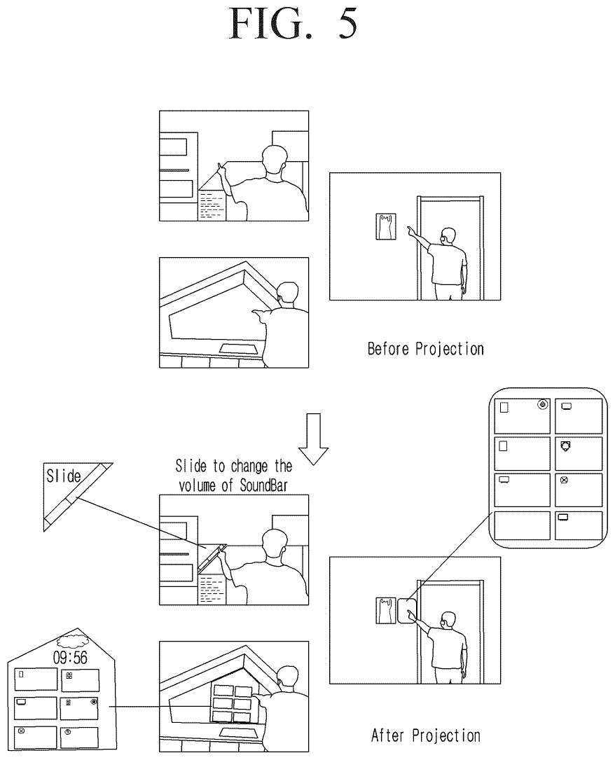

The user is free to walk indoors and may be present in any location in the living room, bedroom, kitchen or work region. At this time, a movable projector can be used so that a user can carry it with him and place it at an appropriate position in any room. In this way, even if the user walks in different spatial regions of the room, the user's environment and the user own body can be detected in real time using the movable projector. In practice, a fixed projector or a movable projector may be used alone in different rooms, which is not limited herein. The camera and sensors in the projector can detect the indoor environment where the user is located and the user own body. As shown in FIG. 5, it is assumed that the user's kitchen basin region, or a wall display region in the office region, or a door is detected. At this time, the camera in the projector can detect a region in front of the basin, a display region, and a region near the door. The camera also detects other regions around the user, which are not listed one by one. For these regions, the size, dimension, three-dimensional coordinate, or the like, of the front of the basin, the display region, and the region near the door are detected. In this operation, the user body information, such as the human body, the proportion of the human body, the size of each body part, or the like, are also detected.

Operation 402: Acquire the user operation intention.

The user operation intention may be obtained by detecting any one or a combination of more of a user voice, a user gesture, a user eyesight, a user facial expression, or in a pre-setting manner. In the embodiment of the disclosure, when the user wants to go out and wants to turn off the indoor electric device, he can lift his hands or say “turn off the switch” or the like, which can determine that the user operation intention is to operate the switch button. As for how to acquire the user operation intention according to any one or a combination of more of user voice, user gesture, user eyesight and user facial expression, or in a pre-setting manner, which can be achieved by the prior art and will not be described here.

Operation 403: Determine a projected region touchable by a user according to three-dimensional space information of an environment where the user is located and three-dimensional space information of the user own body.

After collecting the three-dimensional space information of the environment where the user is located and the three-dimensional space information of the user own body, it is possible to determine where the user's body can touch and can be used for projection.

Operation 404: Select one region from the projected regions touchable by the user as a target projected region according to the acquired user operation intention.

Since there may be a plurality of projected regions meeting the screening conditions, an optimal projected region needs to be selected therefrom. The way for selecting the best projected region may be determined based on the user operation intention. For example, when a user stands at a door, lifts his left hand, it is determine that the user wishes to operate a switch button with his left hand, the projected region touchable by the user nearest the user's left hand is taken as the target projected region.

Operation 405: Perform three-dimensional detection on the target projected region, and determine three-dimensional spatial parameter estimation of an object in the target projected region, where the three-dimensional spatial parameter estimation is spatial position information describing the object in the target projected region.

After determining the target projected region, it is also necessary to determine the three-dimensional parameter estimation of the object in the target projected region to facilitate the subsequent reasonable layout. In an embodiment of the disclosure, it is assumed that the region on the left side of the door is the target projected region. Since there is a wall picture on the left side of the door, if the switch button is directly overlaid and projected on the content, the picture effect is not good and difficult to recognize, this operation can be used to the target projected region can be detected to identify which positions have been covered by content and which positions are relatively blank.

Operation 406: Determine a layout in the target projected region according to the three-dimensional spatial parameter estimation of the object in the target projected region, and generate the layout prompt words from the layout.

Assuming that a blank region on the left side of the door is taken as the target projected region, the specific situation within the target projected region can be determined through three-dimensional detection. It can be seen from FIG. 5 that the left region of the door takes up a relatively sufficient space, and the switch buttons can be arranged in a matrix manner, so that corresponding prompt words, such as “two columns and four rows”, can be generated.

Operation 407: Taking the three-dimensional space information of the target projected region and the layout prompt words as an input of the first diffusion model, and output user interface layout information through calculation of the first diffusion model, where the first diffusion model is a pre-trained model.

The first diffusion model here can be trained for the forward diffusion process and the backward diffusion process by the method as described above. In this operation, using the trained backward diffusion process directly, the three-dimensional space information and the layout prompt words of the target projected region is taking as the input, and the user interface layout information is obtained by calculating from the trained first diffusion model, i.e., specifically generating two columns and four rows of operation button frames.

Operation 408: Determine a user interface style for the target projected region according to the user operation intention, where the user interface style is information describing a style of the user interface appearance.

The embodiment assumes that the user operation intention is to acquire the “color stereoscopic style” by preseting, and then the user interface style of the target projected region can be determined as the “color stereoscopic style” in this operation.

Operation 409: Determine the user interface prompt words for the target projected region according to the user interface style.

This operation determines that the user interface prompt words are “color stereoscopic style” according to the user interface style of the target projected region.

Operation 410: Take three-dimensional space information of the target projected region, user interface layout information and the user interface prompt words as inputs of the second diffusion model, and output the user interface through calculation of the second diffusion model, where the second diffusion model is a pre-trained model.

The second diffusion model here can also be trained for the forward diffusion process and the backward diffusion process according to the method as described above. Using the trained backward diffusion process directly, the three-dimensional space information of the target projected region, the user interface layout information and the user interface prompt words are taking as inputs, and the user interface can be obtained by calculating from the trained second diffusion model in this operation. Assuming that the button of each appliance has a LOGO indicating the appliance, it is possible to place the LOGO of each appliance on the button, or to use a textual representation on each button, such as “TV”, “sound”, “curtain”, “light”, or the like. At this time, two columns and four rows of switch buttons will be generated in this operation, and the switch buttons are display as a color stereoscopic style pattern according to the user's intention.

Operation 410: Project the user interface onto the target projected region, and provide the user interface to the user to realize the user operation intention.

In practice, due to the mounting angle of the projector, the generated user interface can also be corrected using a trapezoidal correction method and then projected.

FIG. 5 is a scenario diagram according to Embodiment 3 of a method according to an embodiment of the disclosure.

Referring to FIG. 5, after projecting the user interface generated in Embodiment 3 of the disclosure onto the target projected region, a switch button will be presented on the left side of the door. In this way, the user does not have to walk to the bedroom or the position of the appliance to operate, but only operates the switch button projected near the left hand.

The above description is made by taking the projection of the switch button on the left side of the door before the user goes out as an example. In practice, it can also be projected elsewhere. Referring to FIG. 5, the switch button can be projected to the region in front of the basin, assuming that the user is in the position of the kitchen basin. If the region is an irregular pentagon, the layout of switch buttons can be planned according to the characteristics of the region and a corresponding user interface can be generated. Similarly, assuming the user is near the display region and wishes to adjust the audio volume, and the display region has a triangular region, then the layout can be planned according to the characteristics of the region and a corresponding user interface can be generated to project a moving bar for adjusting the sound volume onto the triangular region. In summary, by the solution of the embodiment of the disclosure, a user interface can be flexibly generated in a region which is conveniently touchable by a user to provide the generated user interface to the user for operation, which greatly improves the convenience of the user operation and improves the user experience.

The disclosure also provides an apparatus for generating a user interface, which can be deployed in a projector or can be deployed separately.

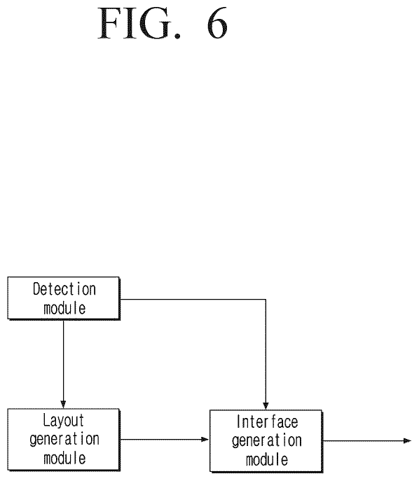

FIG. 6 is a block diagram illustrating Embodiment 1 of an apparatus for generating a user interface according to an embodiment of the disclosure.

Referring to FIG. 6, the apparatus includes: a detection module 601, a layout generation module 602 and an interface generation module 603. Wherein,

The detection module 601 is configured to acquire environmental information and user body information of a user, where the environmental information includes three-dimensional space information of an environment where the user is located, and the user body information includes three-dimensional space information of the user own body, and determining a target projected region according to the three-dimensional space information of the environment where the user is located, the three-dimensional space information of the user own body and an acquired user operation intention.

In practice, the detection module 601 can be a camera and a sensor, or the like, configured for collecting the environmental information and the user body information of the user as well as the user operation intention. The environmental information is three-dimensional space information of an environment where a user is located, and can include but is not limited to the describing the length, width and height dimensions of a space environment, describing the length, width and height dimensions of an object, and can further detect and analyze attribute information such as an object name, an object material and an object softness and hardness. The user own body information is characteristic information describing a three-dimensional space occupied by each body part of the user, and may include but is not limited to a human body height and a human body proportion; and bone detection and bone point detection can also be performed and the length and size of the bone can be analyzed, thereby determining the size and size of each body part, or the like. The user operation intention described herein refers to a user's voluntary meaning expression, and the user operation intention can be obtained by detecting any one or a combination of more of a user voice, a user gesture, a user eyesight, a user facial expression, or in a pre-setting manner.

A layout generation module 602 is configured to determine layout prompt words according to the target projected region and the user operation intention, where the layout prompt words are prompt information describing a user interface layout; and determine user interface layout information according to the target projected region and the layout prompt words using a first diffusion model.

In order to generate a more reasonable aesthetic user interface, the user interface layout is needed to consider in this embodiment. When planning user interface layout, not only the target projected region but also the user operation intention is considered. After the target projected region and layout prompt words are determined, a diffusion model is used to complete the layout in this operation. The diffusion model is a probability-based generation model, which learns the distribution of data by simulating the generation process of data, and can generate new data samples from the learned distribution. The core principles of diffusion model include forward diffusion process and backward diffusion process, which together form the basis of diffusion model. The first diffusion model may be pre-trained using a large number of samples, i.e., using a large number of different projected regions, a large number of different layout prompt words and a large number of different layout information, so that the first diffusion model learns how to generate a reasonably attractive layout according to the layout prompt words for the different projected regions.

An interface generation module 603 is configured to determine user interface prompt words according to the user operation intention, where the user interface prompt words are prompt information describing a user interface appearance; and generate a user interface using a second diffusion model according to the target projected region, user interface layout information and the user interface prompt words.

In practice, the user interface prompt words can be determined according to the user operation intention. After determining the user interface layout information and the user interface prompt words, the generation of the final user interface is completed by using a diffusion model in this operation. The second diffusion model can be pre-trained using a large number of samples, i.e., using a large number of different projected regions, a large number of different user interface layout information and a large number of different user interface prompt words, so that the second diffusion model learns how to generate a final user interface according to the user interface prompt words as for different projected regions and user interface layout information.

With the solution of Embodiment 1 of the apparatus of the disclosure, a user interface can be flexibly generated according to an appropriate position of an environment where a user is located. Thereafter, the generated user interface is projected onto the target projected region and provided to the user to realize the user operation intention, i.e., the user conveniently operates the user interface in the touchable target projected region without using the remote control or other electronic devices such as keyboard, thereby greatly meets the user's requirement.

Embodiments of the disclosure also provide a computer-readable storage medium storing instructions which, when executed by a processor, may perform the operations in the method for generating a user interface as described above. In practice, the computer-readable storage medium may be mounted in the apparatus/device/system described in the embodiments above, or may be separate and not assembled into the apparatus/device/system. The computer-readable storage medium carries one or more programs which, when executed, implement the user interface generation method described in the above embodiments. According to the embodiments disclosed herein, a computer-readable storage medium may be a non-volatile computer-readable storage medium, such as may include, but is not limited to: a portable computer diskette, hard disk, random access memory (RAM), read-only memory (ROM), erasable programmable read-only memory (EPROM or flash memory), portable compact disc read-only memory (CD-ROM), optical storage device, magnetic storage device, or any suitable combination of the above, is not intended to limit the scope of the disclosure. In the embodiments disclosed in the disclosure, a computer-readable storage medium may be any tangible medium that can contain or store a program for use by or in connection with an instruction execution system, apparatus, or device.

Embodiments of the disclosure also provide a computer program product including computer instructions which, when executed by a processor, performs the method as described in any one of the embodiments above.

The flowcharts and block diagrams in the drawings of the disclosure illustrate the architecture, functionality, and operation of possible implementations of systems, methods, and computer program products according to various embodiments disclosed herein. In this regard, each block in the flowchart or block diagrams may represent a module, segment, or portion of code, which includes one or more executable instructions for implementing the specified logical function(s). In some alternative implementations, the functions noted in the blocks may occur out of the order noted in the figures. For example, two consecutive blocks may in fact be executed substantially in parallel, and they may sometimes be executed in the reverse order, depending on the functionality involved. Each block of the block diagrams or flowchart illustrations, and combinations of blocks in the block diagrams or flowchart illustrations, can be implemented by special purpose hardware-based systems which carry out the specified functions or acts, or combinations of special purpose hardware and computer instructions.

It will be appreciated by a person skilled in the art that various combinations and/or combinations of features recited in the various embodiments and/or claims of the disclosure may be made even if such combinations or combinations are not expressly recited in the disclosure. More particularly, various combinations and/or combinations of features recited in the various embodiments and/or claims of the disclosure may be made without departing from the spirit and teachings of the disclosure, and all such combinations and/or combinations fall within the scope of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for generating a user interface, the method comprising:
acquiring environmental information and user body information of a user, wherein the environmental information comprises three-dimensional space information of an environment where the user is located, and the user body information comprises three-dimensional space information of the user's own body;
determining a target projected region according to the three-dimensional space information of the environment where the user is located, the three-dimensional space information of the user's own body and an acquired user operation intention;
determining layout prompt words according to the target projected region and the user operation intention, wherein the layout prompt words are prompt information describing a user interface layout;
determining user interface layout information according to the target projected region and the layout prompt words using a first diffusion model;
determining user interface prompt words according to the user operation intention, wherein the user interface prompt words are prompt information describing a user interface appearance; and
generating a user interface using a second diffusion model according to the target projected region, user interface layout information and the user interface prompt words.

2. The method of claim 1, wherein, after the generating of the user interface using the second diffusion model according to the target projected region, user interface layout information and the user interface prompt words, the method further comprises:
projecting the user interface to the target projected region, and providing the user interface to the user to achieve the user operation intention.

3. The method of claim 1, wherein the determining of the target projected region according to the three-dimensional space information of the environment where the user is located, the three-dimensional space information of the user's own body and the acquired user operation intention comprises:
determining a projected region touchable by the user according to three-dimensional space information of the environment where the user is located and three-dimensional space information of the user's own body; and
selecting one region from the projected regions touchable by the user as a target projected region according to the acquired user operation intention.

4. The method of claim 3, wherein, before the selecting of the one region from the projected regions touchable by the user as a target projected region according to the acquired user operation intention, the method further comprises:
acquiring the user operation intention, wherein the method for acquiring the user operation intention comprises acquiring the user operation intention by detecting any one or a combination of more of a user voice, a user gesture, a user eyesight and a user facial expression.

5. The method of claim 1,
wherein the target projected region is a touchable projected region convenient for the user to operate, and is a regular region or an irregular region, and
wherein the irregular region is a region surrounded by any irregular geometry.

6. The method of claim 1, wherein the determining of the layout prompt words according to the target projected region and the user operation intention comprises:
performing three-dimensional detection on the target projected region;
determining three-dimensional spatial parameter estimation of an object in the target projected region, wherein the three-dimensional spatial parameter estimation is spatial position information describing the object in the target projected region; and
determining a layout in the target projected region according to the three-dimensional spatial parameter estimation of the object in the target projected region, and generating the layout prompt words from the layout.

7. The method of claim 1, wherein the determining of the user interface layout information using a first diffusion model according to the target projected region and the layout prompt words comprises:
taking three-dimensional space information of the target projected region and the layout prompt words as an input of the first diffusion model, and outputting user interface layout information through calculation of the first diffusion model, wherein the first diffusion model is a pre-trained model.

8. The method of claim 1, wherein the determining of the user interface prompt words according to the user operation intention comprises:
determining a user interface style for the target projected region according to the user operation intention, wherein the user interface style is information describing a style of the user interface appearance; and
determining the user interface prompt words for the target projected region according to the user interface style.

9. The method of claim 1, wherein the generating of the user interface using the second diffusion model according to the target projected region, the user interface layout information, and the user interface prompt words comprises:
taking three-dimensional space information about the target projected region, user interface layout information and the user interface prompt words as inputs of the second diffusion model, and outputting the user interface through calculation of the second diffusion model, wherein the second diffusion model is a pre-trained model.

10. An apparatus for generating a user interface, the apparatus comprising:
memory, comprising one or more storage media, storing instructions; and
at least one processor communicatively coupled to the memory,
wherein the instructions, when executed by the at least one processor individually or collectively, cause the apparatus to:
acquire environmental information and user body information of a user, wherein the environmental information comprises three-dimensional space information of an environment where the user is located, and the user body information comprises three-dimensional space information of the user's own body,
determine a target projected region according to the three-dimensional space information of the environment where the user is located, the three-dimensional space information of the user's own body and an acquired user operation intention,
determine layout prompt words according to the target projected region and the user operation intention, wherein the layout prompt words are prompt information describing a user interface layout,
determine user interface layout information according to the target projected region and the layout prompt words using a first diffusion model, determine user interface prompt words according to the user operation intention, wherein the user interface prompt words are prompt information describing a user interface appearance, and
generate a user interface using a second diffusion model according to the target projected region, user interface layout information and the user interface prompt words.

11. The apparatus of claim 10, wherein the instructions, after the generating of the user interface using the second diffusion model according to the target projected region, user interface layout information and the user interface prompt words, when executed by the at least one processor individually or collectively, further cause the apparatus to:
project the user interface to the target projected region, and providing the user interface to the user to achieve the user operation intention.

12. The apparatus of claim 10, wherein the instructions, when executed by the at least one processor individually or collectively, further cause the apparatus to:
determine a projected region touchable by the user according to three-dimensional space information of the environment where the user is located and three-dimensional space information of the user's own body, and
select one region from the projected regions touchable by the user as a target projected region according to the acquired user operation intention.

13. The apparatus of claim 12, wherein the instructions, before the selecting of the one region from the projected regions touchable by the user as a target projected region according to the acquired user operation intention, when executed by the at least one processor individually or collectively, further cause the apparatus to:
acquire the user operation intention, wherein the acquiring the user operation intention comprises acquiring the user operation intention by detecting any one or a combination of more of a user voice, a user gesture, a user eyesight and a user facial expression.

14. The apparatus of claim 10,
wherein the target projected region is a touchable projected region convenient for the user to operate, and is a regular region or an irregular region, and
wherein the irregular region is a region surrounded by any irregular geometry.

15. The apparatus of claim 10, wherein the instructions, when executed by the at least one processor individually or collectively, further cause the apparatus to:
perform three-dimensional detection on the target projected region,
determine three-dimensional spatial parameter estimation of an object in the target projected region, wherein the three-dimensional spatial parameter estimation is spatial position information describing the object in the target projected region, and
determine a layout in the target projected region according to the three-dimensional spatial parameter estimation of the object in the target projected region, and generating the layout prompt words from the layout.

16. One or more non-transitory computer-readable storage media storing one or more computer programs including computer-executable instructions that, when executed by at least one processor of an apparatus individually or collectively, cause the apparatus to perform operations, the operations comprising:
acquiring environmental information and user body information of a user, wherein the environmental information comprises three-dimensional space information of an environment where the user is located, and the user body information comprises three-dimensional space information of the user's own body;
determining a target projected region according to the three-dimensional space information of the environment where the user is located, the three-dimensional space information of the user's own body and an acquired user operation intention;
determining layout prompt words according to the target projected region and the user operation intention, wherein the layout prompt words are prompt information describing a user interface layout;
determining user interface layout information according to the target projected region and the layout prompt words using a first diffusion model;
determining user interface prompt words according to the user operation intention, wherein the user interface prompt words are prompt information describing a user interface appearance; and
generating a user interface using a second diffusion model according to the target projected region, user interface layout information and the user interface prompt words.

17. The one or more non-transitory computer-readable storage media of claim 16, wherein, after the generating of the user interface using the second diffusion model according to the target projected region, user interface layout information and the user interface prompt words, the operations further comprising:
projecting the user interface to the target projected region, and providing the user interface to the user to achieve the user operation intention.

18. The one or more non-transitory computer-readable storage media of claim 16, wherein the determining of the target projected region according to the three-dimensional space information of the environment where the user is located, the three-dimensional space information of the user's own body and the acquired user operation intention comprises:
determining a projected region touchable by the user according to three-dimensional space information of the environment where the user is located and three-dimensional space information of the user's own body; and
selecting one region from the projected regions touchable by the user as a target projected region according to the acquired user operation intention.

19. The one or more non-transitory computer-readable storage media of claim 18, wherein, before the selecting of the one region from the projected regions touchable by the user as a target projected region according to the acquired user operation intention, the operations further comprises:
acquiring the user operation intention, wherein the acquiring of the user operation intention comprises: acquiring the user operation intention by detecting any one or a combination of more of a user voice, a user gesture, a user eyesight and a user facial expression.

20. The one or more non-transitory computer-readable storage media of claim 16, wherein the target projected region is a touchable projected region convenient for the user to operate, and is a regular region or an irregular region, and the irregular region is a region surrounded by any irregular geometry.
